(19) United States
(12) Patent Application Publication
(10) Pub. No.: US 2003/0169537 A1
(43) Pub. Date: Sep. 11, 2003

(54) Armature vibration damper for an armature in a disc storage system

(75) Inventors: Brent Melvin Weichelt, Burnsville, MN (US); Xu Zuo, Prior Lake, MN (US)

Correspondence Address: Judson K. Champlin, Westman, Champlin & Kelly, 900 Second Avenue South, International Centre, Suite 1600, Minneapolis, MN, 55402-3319, US

(73) Assignee: Seagate Technology LLC

(21) Appl. No.: 10/300,063

(22) Filed: Nov. 20, 2002

Related U.S. Application Data
(60) Provisional application No. 60/362,414, filed on Mar. 7, 2002.

(51) Int. Cl. G11B 5/55

(52) U.S. Cl. 360/265.9

(57) ABSTRACT

An apparatus and a method for damping armature vibrations in a disc drive is provided. A vibration damper is attached along a side of an armature. The vibration damper reduces vibrations in the armature during operation of the disc drive.

### CROSS-REFERENCE TO RELATED APPLICATION

This application claims priority from U.S. Provisional Application No. 60/362,414 filed on Mar. 7, 2002 for inventors Brent Melvin Weichelt and Xu Zuo and entitled “E-Block Vibration Damper”.

### FIELD OF THE INVENTION

The present invention relates generally to data storage systems, and more particularly to damping vibration of armatures within data storage systems.

### BACKGROUND OF THE INVENTION

Disc drives are common data storage devices. A typical disc drive includes a rigid housing or deck that encloses a variety of disc drive components. The components include one or more discs having data surfaces coated with a magnetizable, or an optical, medium for storage of digital information in a plurality of circular, concentric data tracks. The discs are mounted on a spindle motor that causes the discs to spin and the data surfaces of the discs to pass under respective hydrodynamic or aerodynamic bearing disc head sliders. The sliders carry transducers, which write information to and read information from the data surfaces of the discs. A head stack assembly (HSA) in a hard disc drive includes a pivot bearing cartridge, a pivot housing (E-block), a record head gimbal assembly (HGA), an actuator voice coil, and additional components.

Armature resonance has been a common problem in disc drives for generations of products. When a hard disc drive is engaged in a data seeking process, the armature motion/vibration/resonance can be large enough to cause functional failure for the drive, e.g. the slider is unable to settle out above the commanded track as rapidly as required. (This is referred to as the seek settle out requirement). As each new generation of hard disc drive demands more recorded tracks per inch (KTPI), fixing or reducing the armature resonance becomes more important.

Known approaches for modifying the armature resonance generally fall into two types. The first approach is to change the geometry of the armature (longer or shorter length, thinner or thicker, etc.) to change the natural resonant frequency of the armature. This type of approach does not permit an easy fix of an existing component, it needs to be re-addressed in the product development cycle for each new generation of hard disc drive as the natural frequency of the armature varies depending on the specific design of the armature, i.e., length, thickness, etc. The second approach is to add damping material on the moving part of the armature to absorb the energy. Some known damping materials use one of more layers of viscoelastic materials, with or without solid, often metal, layers. These damping materials are attached in some way to the top surface of the moving part of the armature or even inside a specially designed armature. These designs are hindered by concerns about the viscoelastic materials outgassing into the disc drive as well as the added complexity of designing armatures with hollow compartments to accommodate the damping materials. Consequently, neither approach is entirely satisfactory.

Embodiments of the present invention address these and other problems, and offer other advantages over the prior art.

### SUMMARY OF THE INVENTION

The present invention is an apparatus and a method for damping armature vibration in a disc drive.

In accordance with one embodiment of the invention, a disc storage system includes a vibration damper on an armature of an E-Block assembly. The vibration damper extends along a side of the armature and reduces vibrations in the armature during operation of the disc storage system.

These and various other features as well as advantages which characterize the present invention will be apparent upon reading the following detailed description and review of the associated drawings.

### BRIEF DESCRIPTION OF THE DRAWINGS

FIG. 1 is an isometric view of a disc drive.

FIG. 2 is a perspective view of an armature without a vibration damper.

FIG. 3 is a plan view of one embodiment of a vibration damper.

FIG. 4 is a cross section of the vibration damper of FIG. 3.

FIG. 5 is a perspective view of the vibration damper of FIG. 3.

FIG. 6 is a perspective view of an armature incorporating a vibration damper.

FIG. 7 is an isometric view of an E-block incorporating a vibration damper on each armature.

FIG. 8 is an isometric view of an E-block incorporating vibration dampers installed in a test apparatus.

FIG. 9 is a graph of experimental results for displacement of an armature both with and without a vibration damper installed.

FIG. 10 is a graph of experimental results for magnitude velocity of an armature both with and without a vibration damper installed.

FIG. 11 is an isometric view of an armature incorporating a vibration damper showing D (vibration damper mounting position).

FIG. 12 is a graph of experimental results for magnitude at the tip of the top arm by adjusting the D (vibration damper mounting position).

### DETAILED DESCRIPTION OF ILLUSTRATIVE EMBODIMENTS

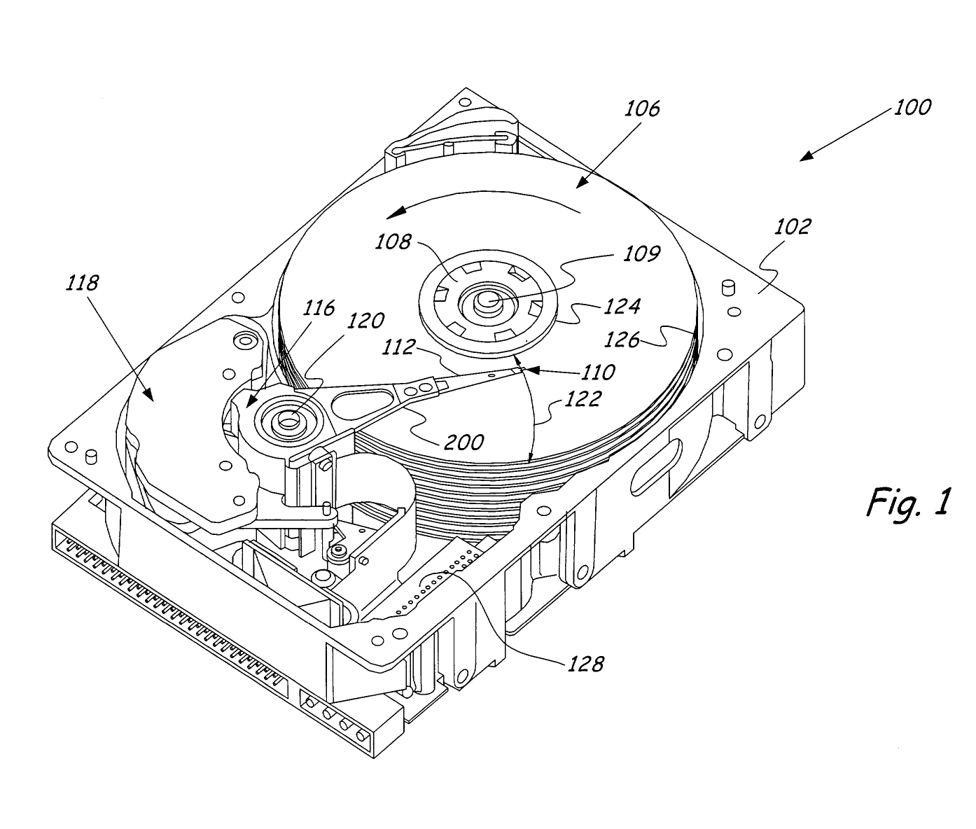

FIG. 1 is an isometric view of a disc drive storage system 100 in which embodiments of the present invention are useful. Drive 100 illustrates either a disc servo writer storage system or a data storage system. Disc drive 100 includes a housing with a base 102. Disc drive 100 further includes a disc pack 106, which is mounted on a spindle motor (not shown) by a disc clamp 108. Disc pack 106 includes a plurality of individual discs, which are mounted for co-rotation about central axis 109. Each disc surface has an associated disc head slider 110 which is mounted to disc drive 100 for communication with the disc surface. In the example shown in FIG. 1, sliders 110 are supported by suspensions 112 which are in turn attached to track accessing arms 200 of an actuator (or an E-block assembly) 116. The actuator shown in FIG. 1 is of the type known as a rotary moving coil actuator and includes a voice coil motor (VCM), shown generally at 118. Voice coil motor 118 rotates actuator 116 with its attached heads 110 about a pivot shaft 120 to position heads 110 over a desired data track along an arcuate path 122 between a disc inner diameter 124 and a disc outer diameter 126. Voice coil motor 118 is driven by servo electronics 128 based on signals generated by heads 110 and a host computer (not shown).

E-Block assembly 116 of disc drive 100 has multiple armatures 200. By contrast, some storage systems use only a single armature. In addition, some factory production equipment, such as servo-writers, use similar armatures. The present invention is applicable to all such configurations. Servo writers are used to write servo data on to blank discs prior to their assembly in a final disc drive storage system. The present invention can be used with all types of E-Block assemblies and armatures in which it is desirable to reduce vibrations.

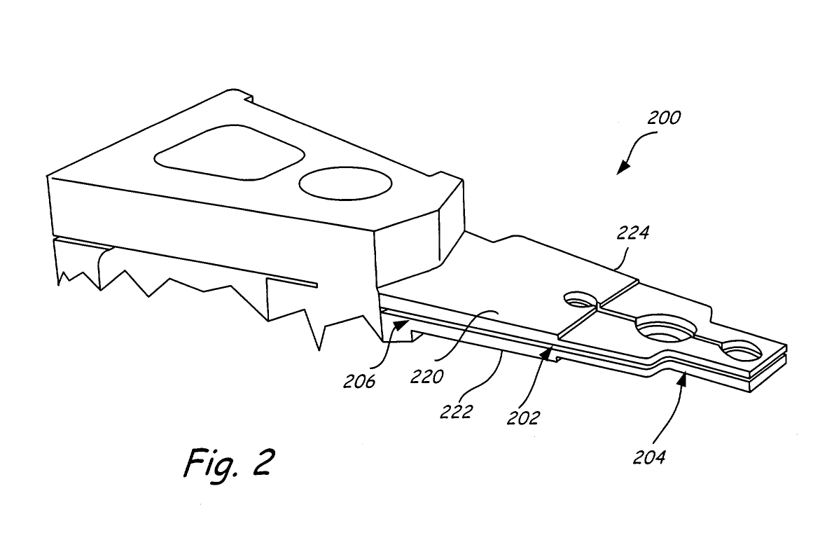

FIG. 2 is a top perspective view of an armature 200 showing a slot 202 configured to receive a vibration damper in accordance with the present invention. Armature 200 is of the type used in E-block assembly 116 shown in FIG. 1. Slot 202 runs along the side 222 of armature 200 and extends between a proximal end 206 and a distal end 204. In this embodiment, armature 200 is an elongate tapered member which tapers in the direction of tip 204. Armature 200 includes a top side 220 and an opposed bottom side (not shown). The top side 220 and bottom side are generally wider flat surfaces and are coupled together by center opposed sides 222 and 224. The slot 202 extends along side 222.

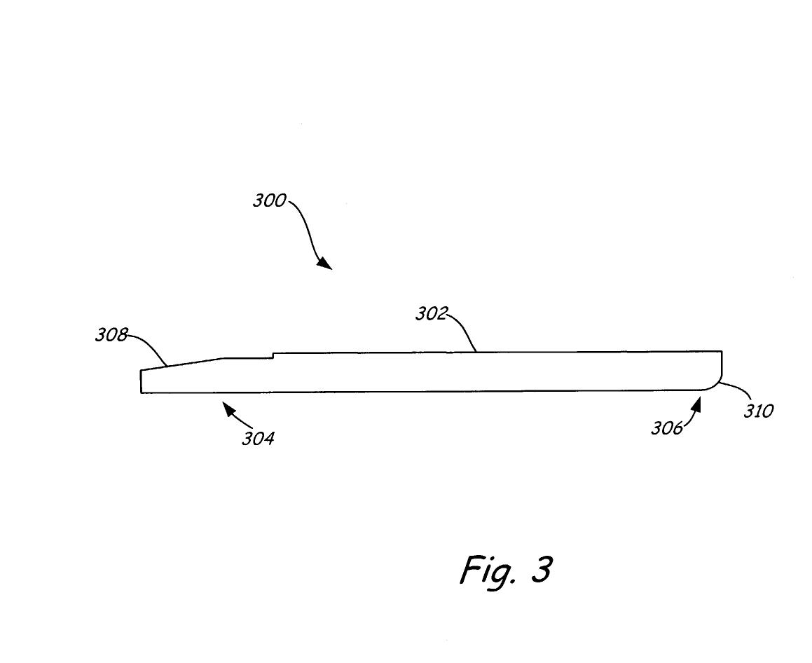

A vibration damper 300 is shown in FIG. 3 in a side plan view for use with the armature 200 of FIG. 2. Damper 300 is configured to be received slot 202 shown in FIG. 2. Damper 300 comprises a damper plate 302 with a curve 308 near damper plate tip 304. Curve 308 provides clearance between vibration damper tip 304 and tip 204 of armature 200. A curve 310 near the proximal end 306 of plate 302 provides clearance between the proximal end 306 of plate 302 and the proximal end 206 of armature 200.

In accordance with the present invention, the vibration damper 300 extends along the side of an armature of an E-Block assembly (including a single armature assembly) and thereby reducing undesired vibrations. The vibration damper can be attached to an E-Block assembly. Further, the specific characteristics of the vibration damper can be varied as desired. For example, a multi-layered damper can be provided and the various layers can be selected as desired along with their thickness. Further, the dimensions and position of the damper can be adjusted. In this embodiment, the vibration damper 300 is illustrated as an elongate member. However, in some embodiments, vibration damper 300 can have other shapes as desired, either to obtain a desired vibration damping characteristic, to conform to the armature 200 or for other purposes.

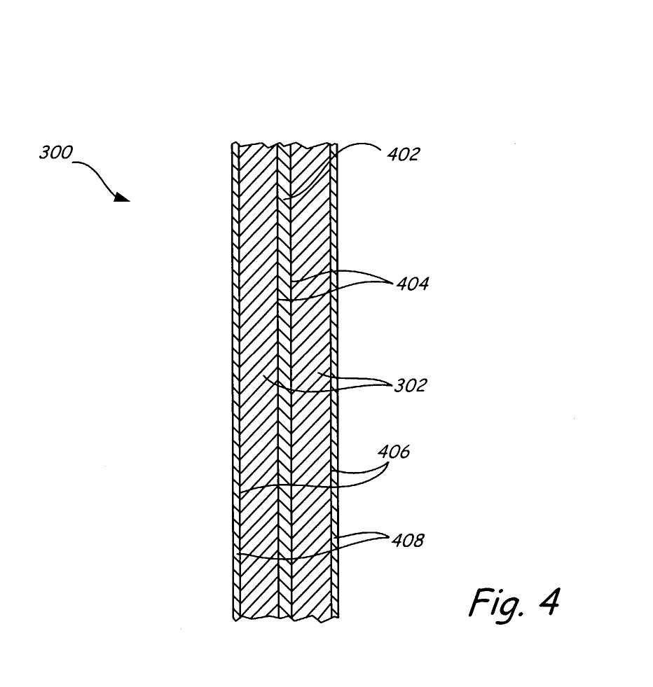

FIG. 4 is a cross section of the vibration damper 300 of FIG. 3. FIG. 4 shows an embodiment in which vibration damper 300 consists of two vibration damper plates 302 joined by a layer of adhesive 402 vibration damper plate inner side 404 of both vibration damper plates 302. In this embodiment, vibration damper plate outer sides 406 of both vibration damper plates 302 are at least partially covered by a second adhesive 408. Adhesives 402 and 408 may be identical for some embodiments of the invention. Adhesive 408 used to attach vibration damper 300 to armature 200.

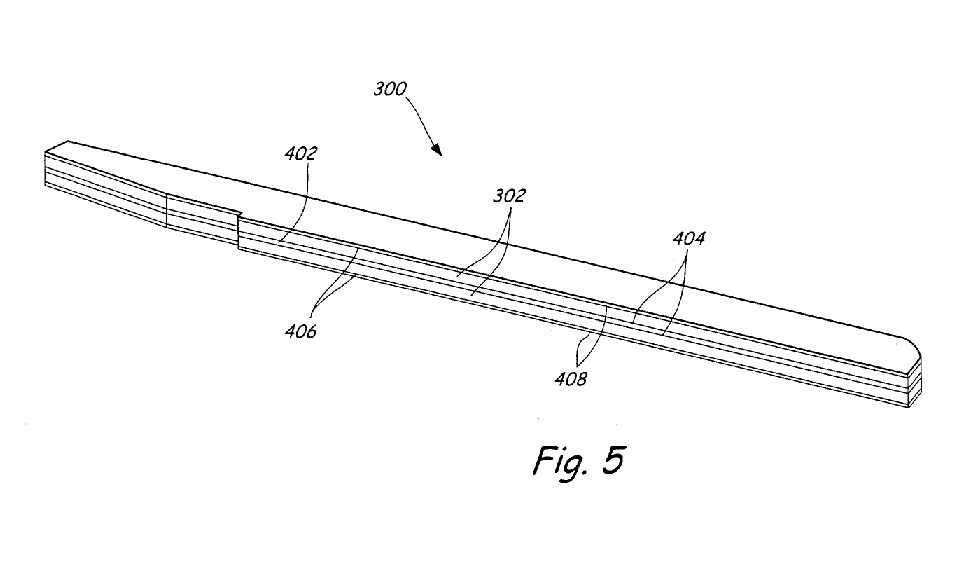

FIG. 5 is a perspective view of the embodiment of the vibration damper of FIGS. 3 and 4. Vibration damper 300 has two vibration damper plates 302 joined by adhesive 402. A second adhesive 408 is on the outer surface of both the vibration damper plates 302. The vibration damper 300, as discussed above, is configured to be received in slot 202 of armature 200.

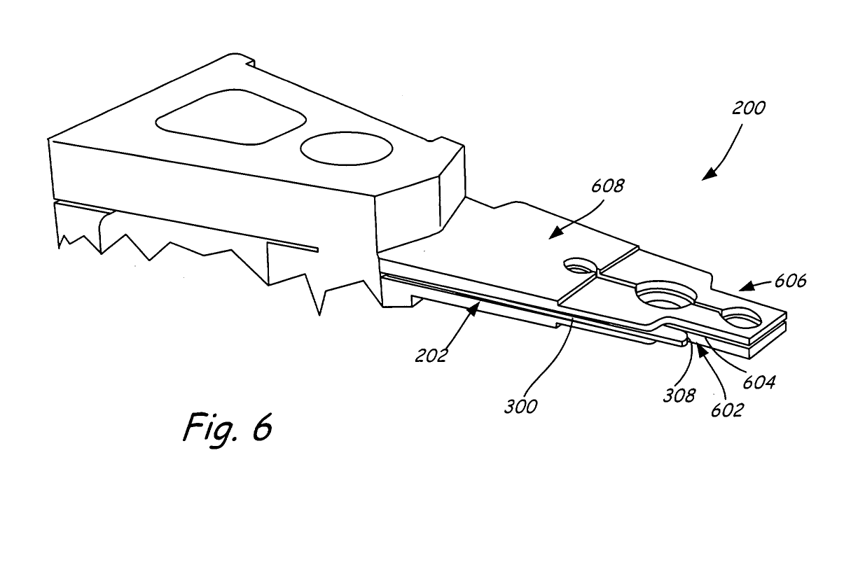

FIG. 6 is a perspective view of an armature incorporating the vibration damper 300. Vibration damper 300 is joined to armature 200 by insertion into slot 202. The damper 300 does not interfere with normal operation of armature 200. However, damper 300 is selected to reduce undesired vibrations which can be induced in armature 200 as armature 200 is moved across the surface of the disc. Other techniques can be used to attach the damper 300 to the armature using any desired technique.

Vibration damper 300 is a “sandwich” structure of two or more vibration damper plates 302 joined by adhesives 402 between each pair of vibration damper plates 302. In one embodiment, two vibration damper plates 302 are joined by a single piece of double sided tape to produce vibration damper 300.

A few steps are taken to join the vibration damper 300 to armature 200. Adhesive 408 is applied to the outside of the vibration damper “sandwich”. This adhesive may be the same adhesive used to join the vibration damper plates 302 to form vibration damper 300. Vibration damper 300, with adhesive 408 on the outside, is pressed into the slot 202 at the edge of the armature 200. In one embodiment of the invention, vibration damper 300 may be removed from the armature 200 or its position adjusted within the armature, by grasping the vibration damper with a clamp, or pliers, and applying force.

Vibration damper 300 is joined to the armature so that there is a gap 602 between curve 308 of vibration damper tip 304 and the outer edge of armature 604. It is important that vibration damper 300 does not contact any portion of tip 204 of armature 200. Testing has shown that any contact between vibration damper 300 and tip 204 greatly reduces, or eliminates, the vibration damping effect of the present invention.

Vibration damper 300 acts in at least two different ways to reduce the vibration of armature 200. The vibration damper 300 adds mass near tip 606 of the armature. Further, vibration damper 300 consumes vibration energy along base 608 of armature 200.

The selection of material for vibration damper plate 302, and the resultant weight of vibration damper plate 302, is related to the weight of armature 200 and E-block 116, to which vibration damper plate 302 is joined. Aluminum, stainless steel, titanium, and brass are example materials which can be used. Stainless steel is desirable in servo-writer assemblies because such assemblies use a relatively heavy stainless steel E-block. In another example embodiment titanium is used with E-block 116 for disc drive 100, because stainless steel is too heavy for use with aluminum E-block 116 of disc drive 100.

Plate 302 can be secured together using any appropriate technique. For example, an adhesive tape having an adhesive layer on either side can be used. In a specific example, HD 11 double-sided tape by Avery can be used. This tape has demonstrated continued performance in vibration damper 300 as it was exposed to environmental stresses. A vibration damper using this tape continued functioning after it was subjected to normal cleaning procedures including more than one week of ultrasonic cleaning.

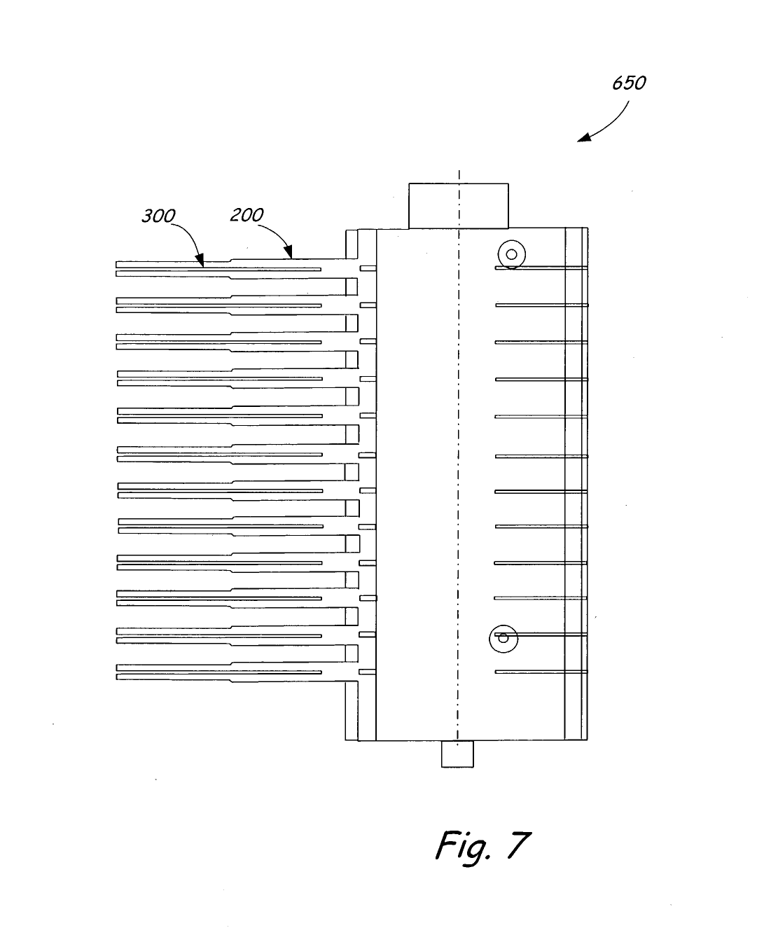

FIG. 7 is an isometric view of an E-block 650 having armatures 200 incorporating vibration damper plates 300. In this embodiment, each of the armatures 200 of the E-block 650 incorporates a vibration damper 300. FIG. 7 shows an E-block which can be used in a servo sector-writer or a disc storage system. A sector-writer is used during manufacture of a disc storage system to write sectors on new manufactured discs prior to their incorporation into finished disc drives.

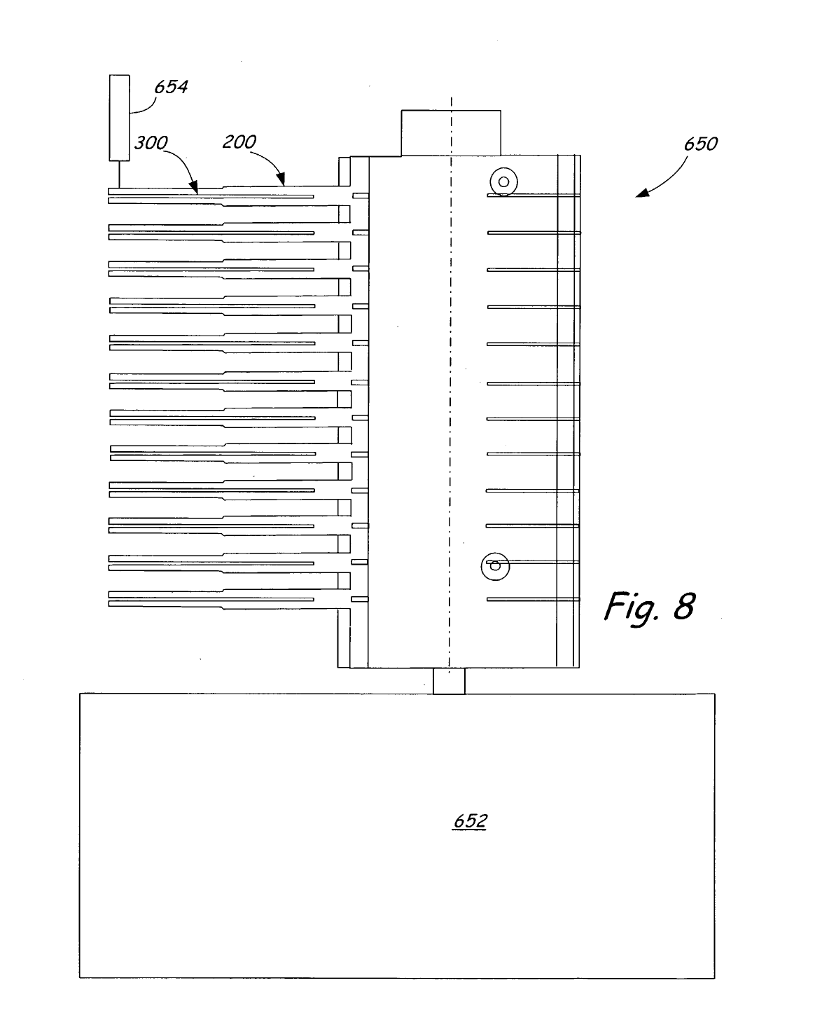

FIG. 8 is an isometric view of an E-block 650 having armatures 200 which incorporating vibration damper plates 300. FIG. 8 shows the E-block 650 of FIG. 7 installed in a test apparatus used during experiments to monitor the unwanted vibrations of E-block 650. The test apparatus includes a shaker 652 operated over a frequency range from 100 Hz to 10 KHz, for example. The position of the tip of the armature 200 is measured with a laser distance sensor (LDV) 654.

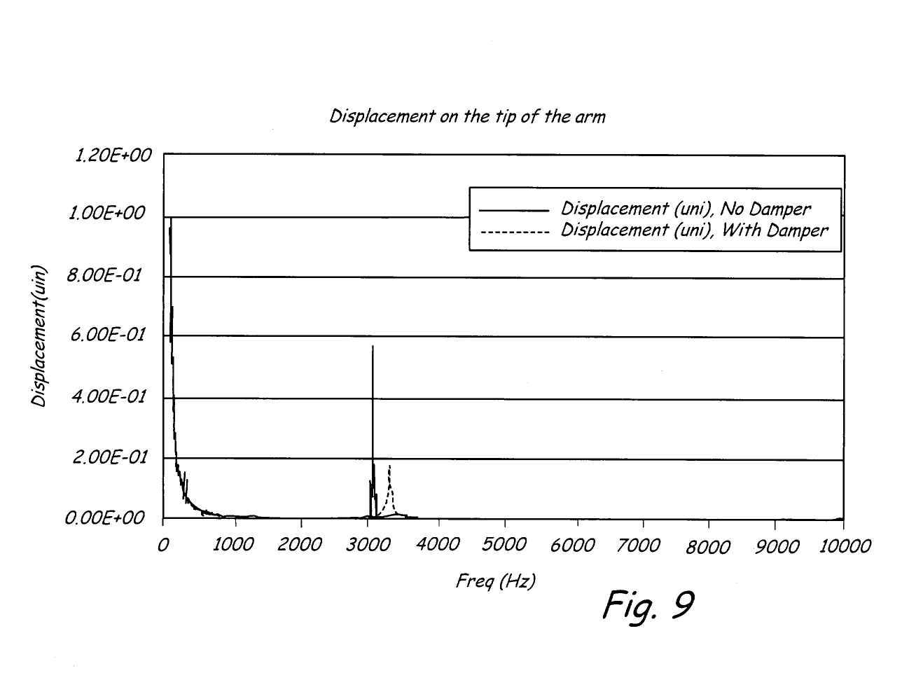

FIG. 9 is a graph of experimental results generated using the arrangement of FIG. 8 showing the displacement of armature 200 both with and without a vibration damper 300 installed. FIG. 9 shows the frequency of shaker 652 in Hertz along the X-axis of the graph and the displacement of the tip of the top armature 200 in micro inches along the Y-axis. As illustrated in the graphs, vibration damper 300 reduces displacement across the entire range of vibration test frequencies. The reduction in vibrations is most dramatic in the range of 3 KHz to 3.5 KHz with damper 300 installed.

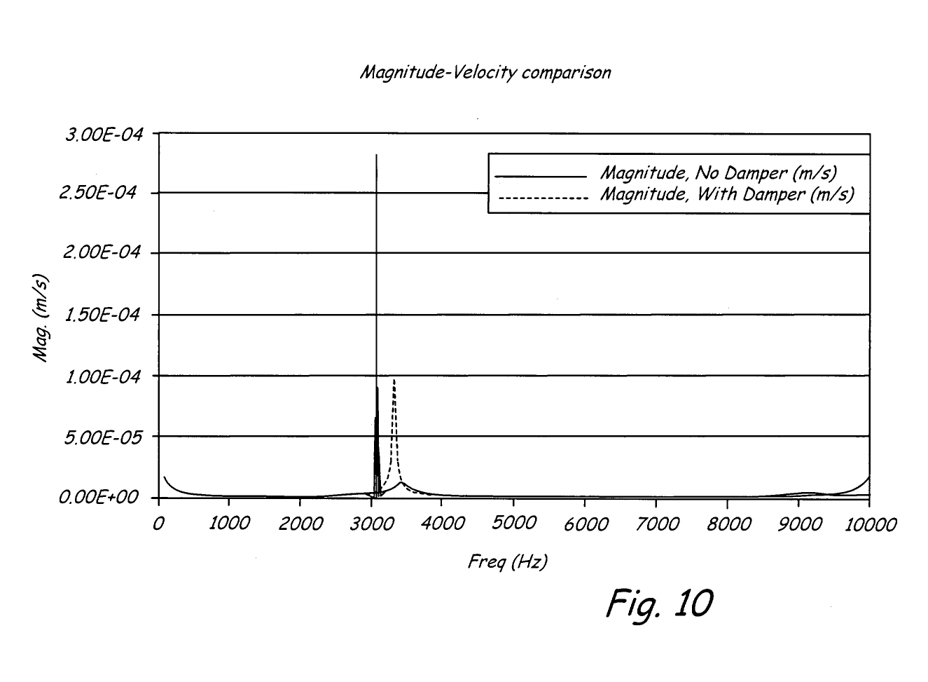

FIG. 10 is a graph of experimental results for velocity magnitude of armature 200, both with and without a vibration damper 300 installed. FIG. 10 shows the frequency of shaker 652 in Hertz along the X-axis of the graph and velocity of the tip of armature 652 in meters per second along the Y-axis. Reduction in velocity occur across the entire vibration frequency range and are most marked between 3 KHz and 3.5 KHz when damper 300 is installed.

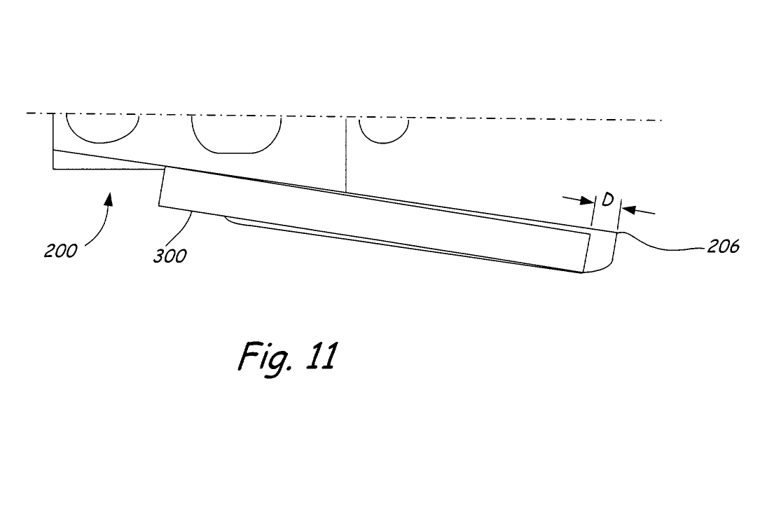

FIG. 11 is an isometric view of an armature 200 incorporating vibration damper 300 showing the offset distance D. D represents a distance of the vibration damper 300 relative to the base of the armature 200. D can be either positive or negative in value, depending on where the vibration damper is mounted relative to base 206 of armature 200. The position can be adjusted as desired and based upon experimentation to obtain optimal for a particular E-block assembly damping characteristics.

In some instances, a small vibration peck at 3.1 KHz and 3 KHz is observed when damper 300 is coupled to armature 200. The occurrence of the peak is related to the vibration damper mounting position on each E-block. This suggests that there is an optimum vibration damper mounting position for each E-block.

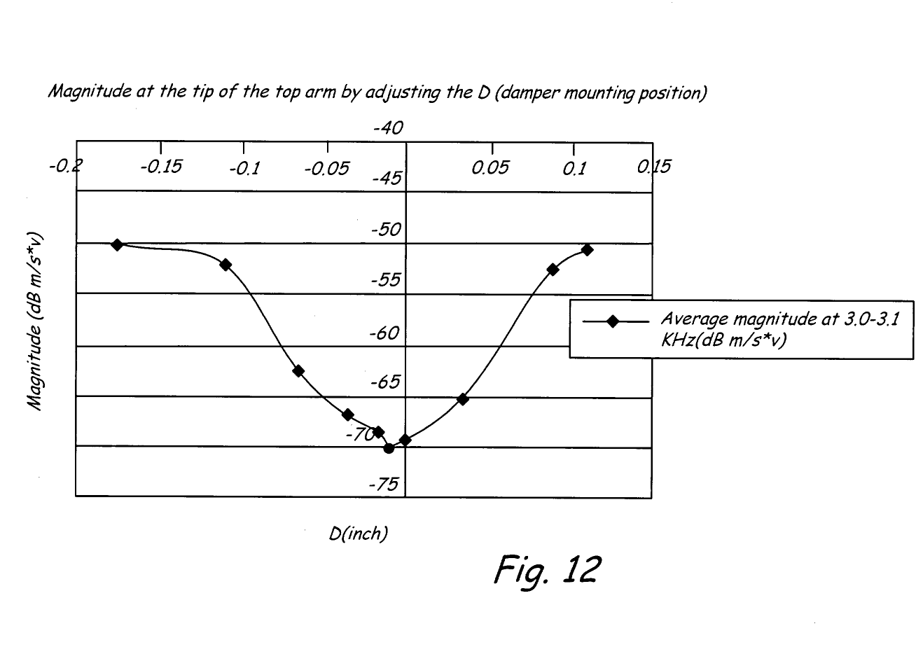

FIG. 12 is a 109 graph of velocity magnitude at the tip 204 of the arm 200 versus D, the offset distance. For this configuration, FIG. 12 illustrates that the optimum vibration damper mounting position for this particular E-block is when with D=−0.01.

An E-block assembly (116) in a disc storage system (100) includes an armature (200). The armature (200) has a tip (204) at one end and a base (206) at the other. A side (222) extends therebetween. A vibration damper (300) couples to the side (222) and is configured to reduce vibrations in the armature (200) during operation of the disc storage system (100). The vibration damper (300) can comprise a plurality of plates (302) coupled together by an adhesive (402). The damper (300) can couple to a slot (202) in armature (200). An adhesive (408) can couple the vibration damper (300) to the armature (200). A method of coupling a vibration damper (300) to an armature (200) is also provided.

It is to be understood that even though numerous characteristics and advantages of various embodiments of the invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed. For example, the particular elements may vary depending on the particular application for the damping system while maintaining substantially the same functionality without departing from the scope and spirit of the present invention. As used herein “E-Block” includes configurations in which there is only a single armature. In one specific embodiment, Avery HD11 is used as adhesive to adhere damper plates together and adhere the damper to the armature. A specific stainless steel which can be used for the damper is 304 stainless steel.

What is claimed is:

1. An E-Block assembly for use in a disc storage system comprising:
an E-Block having at least an armature with a tip at one end of the armature and a base at the other end of the armature, the armature having a side which extends therebetween; and
a vibration damper coupled to the side of the armature configured to reduce vibrations in the armature during operation of the disc storage system.

2. The apparatus of claim 1 wherein the vibration damper comprises a plurality of vibration damper plates joined together.

3. The apparatus of claim 2 wherein the vibration damper plates are joined together by an adhesive.

4. The apparatus of claim 3 wherein the adhesive comprises a double-sided tape.

5. The apparatus of claim 1 wherein the vibration damper comprises stainless steel.

6. The apparatus of claim 2 wherein the vibration damper plates comprises two plates joined together.

7. The apparatus of claim 1 wherein the vibration damper is joined to the armature by adhesive applied to an outer side of the vibration damper.

8. The apparatus of claim 1 wherein the vibration damper is received in a slot in the armature.

9. The apparatus of claim 1 including a second vibration damper joined to the armature along a second side.

10. The apparatus of claim 1 wherein is the E-block includes a plurality of armatures and each armature includes a vibration damper.

11. The apparatus of claim 1 wherein the vibration damper is elongated and adhered along the side of the armature.

12. The apparatus of claim 1 wherein the E-block includes a single armature.

13. A method of damping vibration of an armature of a disc drive, comprising:
obtaining a vibration damper; and
joining the vibration damper to a side of the armature.

14. The method of claim 13 wherein obtaining a vibration damper comprises attaching a plurality of damper plates together.

15. The method of claim 13 wherein the plates are attached with double sided tape.

16. The method of claim 13 wherein the vibration damper comprises stainless steel.

17. The method of claim 13 further comprising;
obtaining a second of vibration damper and attaching the second vibration damper to a second side of the armature.

18. The method of claim 13 further comprising:
attaching vibration dampers to a plurality of armatures of an E-block.

19. A disc drive comprising:
an E-Block assembly comprising at least one armature and; and vibration damper means attached along a side of the armature for damping vibrations of the armature during operation of the disc drive.

20. The apparatus of claim 19 wherein the vibration damper means is coupled to a side of the armature means.

21. The apparatus of claim 19 wherein the vibration damper means comprises two vibration damper plates joined together.

22. The apparatus of claim 19 wherein the vibration damper means is received in a slot of the armature means.
